(19) United States
(12) Patent Application Publication
(10) Pub. No.: US 2022/0351110 A1
(43) Pub. Date: Nov. 3, 2022

(54) FUEL SUPPLY-DEMAND MATCHING SYSTEM

(71) Applicant: HONDA MOTOR CO., LTD., Tokyo (JP)

(72) Inventors: Daishi Yasuda, Wako-shi (JP); Shintaro Aoyagi, Wako-shi (JP)

(21) Appl. No.: 17/698,346

(22) Filed: Mar. 18, 2022

(30) Foreign Application Priority Data
Apr. 30, 2021 (JP) 2021-077045

(51) Int. Cl. G06Q 10/06; G06Q 10/00

(52) U.S. Cl. CPC G06Q 10/06315; G06Q 10/20

(57) ABSTRACT

Based on business operator information including the type of business or the location of a refueling base of an operating asset and on supplier information including the type of fuel and the location of a supply base, a fuel supply-demand matching system extracts and outputs a suitable supplier for a business operator by using matching conditions provided for each business operator that include the compatibility between the operating asset and the type of fuel and the relationship between the location of the refueling base and the location of the supply base.

### INCORPORATION BY REFERENCE

The present application claims priority under 35 U.S.C.§ 119 to Japanese Patent Application No. 2021-077045 filed on Apr. 30, 2021. The content of the application is incorporated herein by reference in its entirety.

### BACKGROUND OF THE INVENTION

### Field of the Invention

The present invention relates to a fuel supply-demand matching system that matches a business operator who consumes fuel with a fuel supplier.

### Description of the Related Art

Japanese Patent Laid-Open No. 2015-228073 describes a delivery planning system that outputs information needed to reduce fuel delivery costs based on a planned amount of delivery according to an amount of fuel stock, a demand prediction, and a stock prediction at a consumer facility and to the type and the number of fuel delivery vehicles.

Japanese Patent Laid-Open No. 2019-102080 describes a fuel delivery management system that, based on pieces of information including information about the location of a heavy machine that is owned by a customer and needs refueling and an allowable refueling amount thereof, and information about a current position of a fuel delivery vehicle and an allowable transportation amount thereof, notifies the customer of an estimated time of arrival of the fuel delivery vehicle at the location where the heavy machine is present.

### SUMMARY OF THE INVENTION

In recent years, non-fossil fuels that produce less CO₂ emissions than petroleum-derived fossil fuels have been drawing attention as fuels for vehicles, such as cars, toward the realization of a decarbonized society that achieves zero emissions of greenhouse gases that lead to global warming. Non-fossil fuels refer to fuels that do not use petroleum-derived fossil fuels, and examples include biofuels (biomass fuels) that use biomass ethanol produced from organisms, such as corn, sugarcane, and cassava, and synthetic liquid fuels (so-called e-fuels) that are composed of carbon dioxide and hydrogen. For example, in the field of aircraft, there has been continuous effort to promote the use of sustainable aviation fuels (or renewable alternate aviation fuels) called aviation biofuels or sustainable aviation fuels (SAFs).

Such non-fossil fuels are generally used in the form of mixed fuels by being mixed with fossil fuels, and there can be various mixed fuels with different ratios of mixture with fossil fuels (or different contents of non-fossil fuels). As a result, the amount of CO₂ emission and the combustion efficiency (or the energy that can be obtained per unit consumption amount) of mixed fuels can vary according to the type of mixed fuel.

Thus, in the field of aircraft, for example, usable mixed fuels may be limited to a specific type according to the type of aircraft, or some airlines owning aircraft may selectively use mixed fuels that produce less carbon emissions. On the other hand, since mixed fuels come in various types, there is a limit to how many types of mixed fuels one fuel supplier can supply, and the types of mixed fuels that can be handled can be limited depending on the fuel supplier. This makes it difficult for airlines to find a fuel supplier near a refueling site of aircraft who can supply a mixed fuel that meets necessary conditions, which can constitute an obstacle to introducing non-fossil fuels.

Having been contrived in view of this situation, the present invention effectively matches a business operator who does business using an operating asset that consumes fuel, such as an aircraft, with a fuel supplier who supplies fuel as business.

One aspect of the present invention is a fuel supply-demand matching system including: a storage device that stores business operator information about business operators who do business using an operating asset that operates by consuming fuel, and supplier information about suppliers who supply the fuel as business; and a matching unit that, based on the business operator information and the supplier information, extracts and outputs a suitable supplier for a business operator to receive a supply of the fuel from by using given matching conditions. The business operator information includes information about the type of the business or the operating asset used in the business of each of the business operators, and information about the location of a refueling base of the operating asset. The supplier information includes information about the type of the fuel supplied by each of the suppliers, and information about the location of a supply base of the fuel. The matching conditions include a first condition about the compatibility between the operating asset and the type of fuel, and a second condition about the geographical relationship between the refueling base and the supply base, both the conditions being provided for each of the business operators.

Another aspect of the present invention is a fuel supply-demand matching method executed by a computer, and includes the steps of: storing, in a storage device, business operator information about business operators who do business using an operating asset that operates by consuming fuel; storing, in the storage device, supplier information about suppliers who supply the fuel as business; and, based on the business operator information and the supplier information, extracting and outputting a suitable supplier for a business operator to receive a supply of the fuel from by using given matching conditions. The business operator information includes information about the type of the business or the operating asset used in the business of each of the business operators, and information about the location of a refueling base of the operating asset. The supplier information includes information about the type of the fuel supplied by each of the suppliers, and information about the location of a supply base of the fuel. The matching conditions include a first condition about the compatibility between the operating asset and the type of fuel, and a second condition about the geographical relationship between the refueling base and the supply base, both the conditions being provided for each of the business operators.

The present invention can effectively match a business operator who does business using an operating asset that consumes fuel with a fuel supplier who supplies fuel as business.

### BRIEF DESCRIPTION OF THE DRAWINGS

FIG. 1 is a view showing the configuration of a fuel supply-demand matching system according to one embodiment of the present invention;

FIG. 2 is a view showing one example of the configuration of a business operator server that constitutes a part of the fuel supply-demand matching system shown in FIG. 1;

FIG. 3 is a view showing one example of the configuration of a supplier server that constitutes a part of the fuel supply-demand matching system shown in FIG. 1;

FIG. 4 is a view showing one example of the configuration of an equipment information server that constitutes a part of the fuel supply-demand matching system shown in FIG. 1;

FIG. 5 is a view showing one example of the configuration of a matching server that constitutes a part of the fuel supply-demand matching system shown in FIG. 1;

FIG. 6 is a view showing one example of business operator information stored in the matching server;

FIG. 7 is a view showing one example of a flight history as an operation history included in the business operator information of FIG. 6;

FIG. 8 is a view showing one example of a maintenance history included in the business operator information of FIG. 6;

FIG. 9 is a view showing one example of supplier information stored by the matching server;

FIG. 10 is a view showing one example of a display screen, on a mobile terminal, of a degree of reduction of environmental load output by an evaluation unit of the matching server; and

FIG. 11 is a view showing one example of the procedure of a fuel supply-demand matching method according to one embodiment of the present invention.

### DETAILED DESCRIPTION OF THE PREFERRED EMBODIMENT

An embodiment of the present invention will be described below with reference to the drawings.

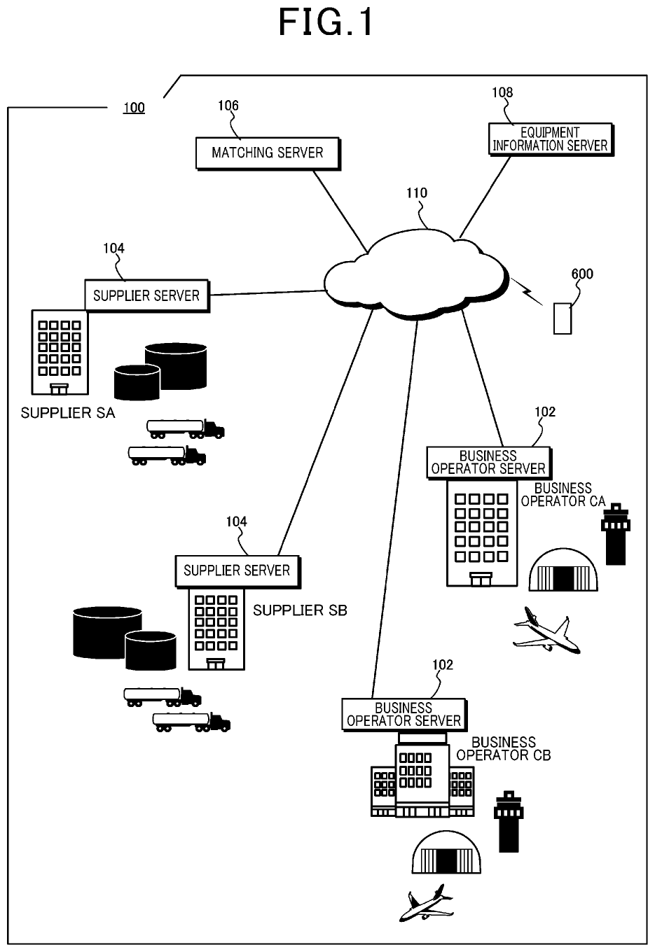

FIG. 1 is a view showing the configuration of a fuel supply-demand matching system according to one embodiment of the present invention. A fuel supply-demand matching system 100 matches a business operator who does business using mechanical equipment as an operating asset that operates by consuming fuel with a supplier who supplies fuel as business. In this embodiment, business operators are airlines that transport passengers and freight using aircraft as operating assets. In this embodiment, the types of fuels supplied by suppliers include non-fossil fuels including biofuels and synthetic liquid fuels, and/or mixed fuels of non-fossil fuels and petroleum-derived fossil fuels. Hereinafter, these mixed fuels of non-fossil fuels and fossil fuels will be referred to simply as “mixed fuels.”

The fuel supply-demand matching system 100 includes a business operator server 102 that a business operator operates or uses, a supplier server 104 that a supplier operates or uses, and a matching server 106 that matches a business operator with a supplier in relation to supply and demand of fuel. The fuel supply-demand matching system 100 may further include an equipment information server 108.

Based on contracts with pluralities of business operators and suppliers, for example, an operator of the matching server 106 establishes the fuel supply-demand matching system 100 and executes the matching by the matching server 106 on the condition that the operator obtains compensations from these business operators and suppliers.

The business operator server 102 provides the matching server 106 with information about operating assets that a corresponding business operator uses in business. The information about the operating assets can include pieces of information such as the type, the model, the location of a refueling base (e.g., a parking apron), an operation history, and a maintenance history of each operating asset.

The supplier server 104 provides the matching server 106 with information about fuel supply by a corresponding supplier. The information about fuel supply includes pieces of information such as the type, the ratio of non-fossil fuels, the sales unit price, the location of a supply base, and the transportation unit price of each fuel supplied by that supplier.

The equipment information server 108 provides the matching server 106 with information about the specifications and the performance of the operating assets. The information about the specifications and the performance can include pieces of information such as a compatible fuel, a throughput per fuel consumption amount, recommended frequency of maintenance work, and/or the prices of service parts of each piece of mechanical equipment that is an operating asset. The equipment information server 108 can be, for example, a server that a manufacturer of mechanical equipment that is operating assets operates or uses.

In the example shown in FIG. 1, the fuel supply-demand matching system 100 includes one matching server 106, two business operator servers 102 that two business operators CA and CB respectively operate or use, two supplier servers 104 that two suppliers SA and SB respectively operate or use, and one equipment information server 108. However, this is one example, and the fuel supply-demand matching system 100 can include arbitrary numbers of business operator servers 102 and supplier servers 104 that arbitrary numbers, not less than one, of business operators and/or suppliers respectively operate or use, and an arbitrary number of equipment information servers 108. In this case, each of the equipment information servers 108 can be a server that a different mechanical equipment manufacturer operates or uses.

The business operator servers 102, the supplier servers 104, the matching server 106, and the equipment information server 108 are communicably connected to one another through a communication network 110. The communication network 110 can be an open network, such as the Internet, a private network, or a closed network. A mobile terminal 600, such as a smartphone, of a user of the fuel supply-demand matching system 100 may be communicably connected to the communication network 110. The user can be, for example, a manager, an investor, a stockholder, or the like of the business operator that operates the business operator server 102, and can be a user who has a predetermined access right for the matching server 106 etc. of the fuel supply-demand matching system 100.

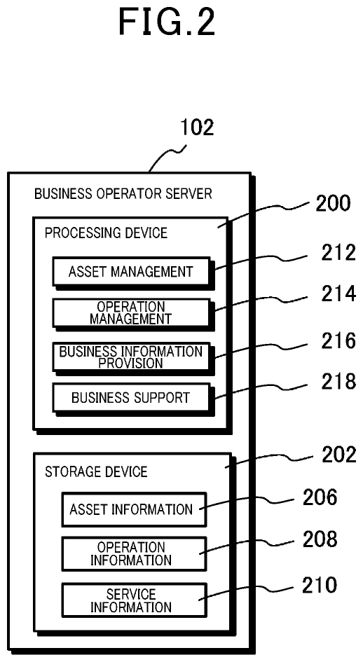

FIG. 2 is a view showing one example of the configuration of the business operator server 102. The business operator server 102 includes a processing device 200 and a storage device 202. The storage device 202 is formed by, for example, a volatile or non-volatile semiconductor memory, and/or a hard disk device or the like. The storage device 202 stores asset information 206, operation information 208, and service information 210.

The asset information 206 is information about the operating assets that the business operator owns, and includes, for example, pieces of information such as the type, the model, and the location of the refueling base of each operating asset. Here, a refueling base refers to a place where the operating asset is refueled. In this embodiment, operating assets are aircraft, and the asset information can include pieces of information such as the plane ID, the plane model, and the location of the refueling base of each aircraft owned by the corresponding business operator.

The operation information 208 is information about an operation history of each operating asset of the business operator, and includes pieces of information on each operating asset such as the date of refueling, the type of fuel fed, the consumption amount of the fuel fed, and a throughput of the operating asset corresponding to the consumption amount. Here, a throughput in this specification refers to an amount of result produced by an operating asset by consuming a predetermined amount of fuel. For example, when the operating asset is a machine for producing products, the throughput of the operating asset can be the amount of products created by the production machine or the amount of profit corresponding to the amount of products created.

Or when the operating asset is a freight transportation machine, for example, the throughput of the operating asset can be the distance or the amount of freight that the transportation machine has transported, or the amount of profit corresponding to the amount of freight transported. In this embodiment, the throughput is, for example, a distance that an aircraft that is an operating asset owned by a business operator flows by consuming a predetermined amount of fuel.

The service information 210 is information about a maintenance history of each operating asset of the business operator, and can include, for example, information about the date on which maintenance is performed and the cost required for the maintenance of each operating asset. Here, the cost required for maintenance can be a total cost required for maintenance, including a labor cost, a parts cost, and an electricity expense involved in the work.

The processing device 200 is a computer including a processor, for example, a central processing unit (CPU). The processing device 200 may be configured to have a read-only memory (ROM) in which programs are written, a random-access memory (RAM) that temporarily stores data, etc. The processing device 200 includes an asset management unit 212, an operation management unit 214, a business information provision unit 216, and a business support unit 218 as functional elements or functional units.

These functional elements included in the processing device 200 are realized, for example, as the processing device 200 that is a computer executes programs. These computer programs can be stored in an arbitrary computer-readable storage medium. Alternatively, all or some of the functional elements included in the processing device 200 may be each formed by hardware including one or more electronic circuit parts.

The asset management unit 212 generates or updates the asset information 206 based on, for example, information input from an operator of the corresponding business operator, and stores that information in the storage device 202.

Similarly, the operation management unit 214 generates or updates the operation information 208 and the service information 210 based on, for example, information input from the operator of the corresponding business operator, and stores these pieces of information in the storage device 202.

When one of the asset information 206, the operation information 208, and the service information 210 is updated, the business information provision unit 216 sends the updated information to the matching server 106. In addition to or instead of this, the business information provision unit 216 may send the asset information 206, the operation information 208, and the service information 210 to the matching server based on a request from the matching server 106 or on a regular basis.

The business support unit 218 sends a matching request to the matching server 106 in response to, for example, a command input from the operator of the business operator, and receives a matching result sent from the matching server 106. This matching request may include information needed for matching, for example, information about an identification ID of an operating asset to be refueled (e.g., a plane ID to be described later), limitation of the type of required fuel, and/or a required amount of fuel.

In response to a command input from the operator of the business operator, the business support unit 218 places an order for the required fuel with a supplier indicated by the received matching result.

Further, the business support unit 218 sends a request for business support information to the matching server 106 in response to a command input from the operator of the business operator, and receives business support information (to be described later) from the matching server 106. Upon receiving an order from the operator, the business support unit 218 outputs the received business support information by an appropriate output device (not shown), such as a display device. The output business support information is used, for example, to determine a business operation policy etc. at the business operator.

When the business support unit 218 receives information on a compensation for the received business support information from the matching server 106, as in the related art, the business support unit 218 pays the compensation to the operator of the matching server 106 in response to, for example, an approval input from the operator.

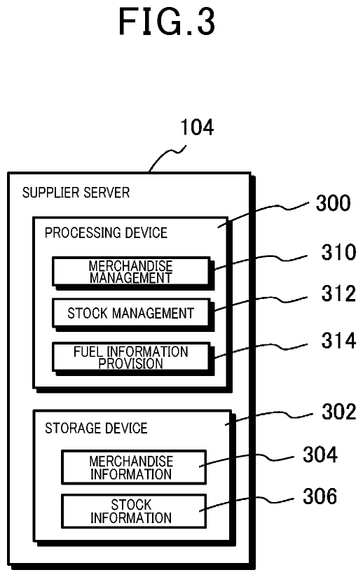

FIG. 3 is a view showing one example of the configuration of the supplier server 104. The supplier server 104 includes a processing device 300 and a storage device 302. The storage device 302 is formed by, for example, a volatile or non-volatile semiconductor memory, and/or a hard disk device or the like. The storage device 302 stores merchandise information 304 and stock information 306.

The merchandise information 304 is information about fuels that are merchandises that the corresponding supplier sells. For example, the merchandise information 304 includes information about the type, the ratio of non-fossil fuels, the location of a supply base, and the transportation unit price of each fuel that the supplier sells. As described above, in this embodiment, the types of fuels include non-fossil fuels or mixed fuels of non-fossil fuels and fossil fuels.

The ratio of non-fossil fuels is the content of non-fossil fuels in each type of fuel. In the case where the ratio of non-fossil fuels is stipulated by a standard, such as a national standard or an international standard, the ratio of non-fossil fuels can be represented by, instead of a numerical value, information such as a name, a classification code, or the like of each type of fuel provided in the corresponding standard. A supply base refers to a place from which the fuel is sent. A fuel sent from a supply base is transported to a refueling base of a business operator who is an addressee by arbitrary transportation means, such as a vehicle like a tank lorry, or a tank vehicle using a railway. The transportation unit price can be, for example, a transportation fee per distance of transportation.

The stock information 306 includes information about a stock amount and the sales unit price of each type of fuel.

The processing device 300 is a computer including a processor, for example, a CPU. The processing device 300 may be configured to have an ROM in which programs are written, an RAM that temporarily stores data, etc. The processing device 300 includes a merchandise management unit 310, a stock management unit 312, and a fuel information provision unit 314 as functional elements or functional units.

These functional elements included in the processing device 300 are realized, for example, as the processing device 300 that is a computer executes programs. These computer programs can be stored in an arbitrary computer-readable storage medium. Alternatively, all or some of the functional elements included in the processing device 300 can be each formed by hardware including one or more electronic circuit parts.

The merchandise management unit 310 generates or updates the merchandise information 304 based on, for example, information input from an operator of the supplier, and stores that information in the storage device 302.

Similarly, the stock management unit 312 generates or updates the stock information 306 based on, for example, information input from the operator of the supplier, and stores that information in the storage device 302.

When one of the merchandise information 304 and the stock information 306 is updated, the fuel information provision unit 314 sends the updated information to the matching server 106. Instead of or in addition to this, the fuel information provision unit 314 may send the merchandise information 304 and the stock information 306 to the matching server based on a request from the matching server 106 or on a regular basis.

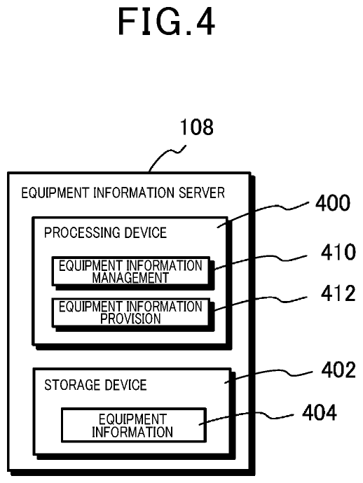

FIG. 4 is a view showing one example of the configuration of the equipment information server 108. As described above, the equipment information server 108 can be a server that, for example, a manufacturer of mechanical equipment that is operating assets owned by a business operator operates or uses.

The equipment information server 108 includes a processing device 400 and a storage device 402. The storage device 402 is formed by, for example, a volatile or non-volatile semiconductor memory, and/or a hard disk device or the like. The storage device 402 stores equipment information 404.

The equipment information 404 includes information about the specifications, the performance, maintenance, etc. of each mechanical device that is an operating asset owned by a business operator. In this embodiment, the equipment information 404 can include pieces of information about each model of aircraft that is an operating asset, such as the type of compatible fuel, the fuel efficiency of each type of fuel, and a recommended interval of maintenance (e.g., a distance to be flown from when maintenance is performed until next maintenance become necessary).

The processing device 400 is a computer including a processor, for example, a CPU. The processing device 400 may be configured to have an ROM in which programs are written, an RAM that temporarily stores data, etc. The processing device 400 includes an equipment information management unit 410 and an equipment information provision unit 412 as functional elements or functional units.

These functional elements included in the processing device 400 are realized, for example, as the processing device 400 that is a computer executes programs. These computer programs can be stored in an arbitrary computer-readable storage medium. Alternatively, all or some of the functional elements included in the processing device 400 can be each formed by hardware including one or more electronic circuit parts.

The equipment information management unit 410 generates or updates the equipment information 404 based on, for example, information input by an operator, and stores that information in the storage device 402.

Based on a request from the matching server 106, the equipment information provision unit 412 sends a requested piece of the equipment information 404 to the matching server 106.

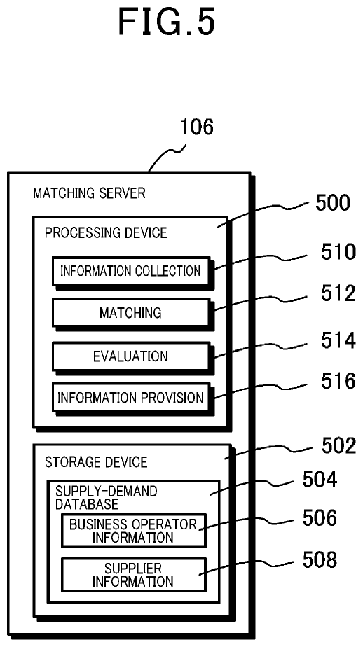

FIG. 5 is a view showing one example of the configuration of the matching server 106. The matching server 106 includes a processing device 500 and a storage device 502. The storage device 502 is formed by, for example, a volatile or non-volatile semiconductor memory, and/or a hard disk device or the like, and stores a supply-demand database 504. The supply-demand database 504 includes business operator information 506 and supplier information 508. The business operator information 506 is information about business operators who do business using operating assets that consume fuel, and supplier information 508 is information on suppliers who supply fuel as business.

The business operator information 506 includes information about what operating assets each business operator uses in business, and information about the location of a refueling base for feeding fuel, a compatible fuel, an operation history, and a maintenance history of each operating asset. The supplier information 508 includes information about the type, the ratio of non-fossil fuels, the location of a fuel supply base, the sales unit price, and the transportation unit price of each fuel supplied by each supplier. As described above, the types of fuels supplied by the suppliers include non-fossil fuels or mixed fuels of non-fossil fuels and fossil fuels. An information collection unit 510, to be described later, collects these pieces of information and stores them in the storage device 502.

The processing device 500 is a computer including a processor, for example, a CPU. The processing device 500 may be configured to have an ROM in which programs are written, an RAM that temporarily stores data, etc. The processing device 500 includes the information collection unit 510, a matching unit 512, an evaluation unit 514, and an information provision unit 516 as functional elements or functional units.

These functional elements included in the processing device 500 are realized, for example, as the processing device 500 that is a computer executes programs. These computer programs can be stored in an arbitrary computer-readable storage medium. Alternatively, all or some of the functional elements included in the processing device 500 can be each formed by hardware including one or more electronic circuit parts.

The information collection unit 510 collects information from the business operator server 102 and the equipment information server 108 and generates the business operator information 506, and stores the generated business operator information 506 in the supply-demand database 504 stored in the storage device 502. Further, the information collection unit 510 collects information from the supplier server 104 and generates the supplier information 508, and stores the generated supplier information 508 in the supply-demand database 504 stored in the storage device 502.

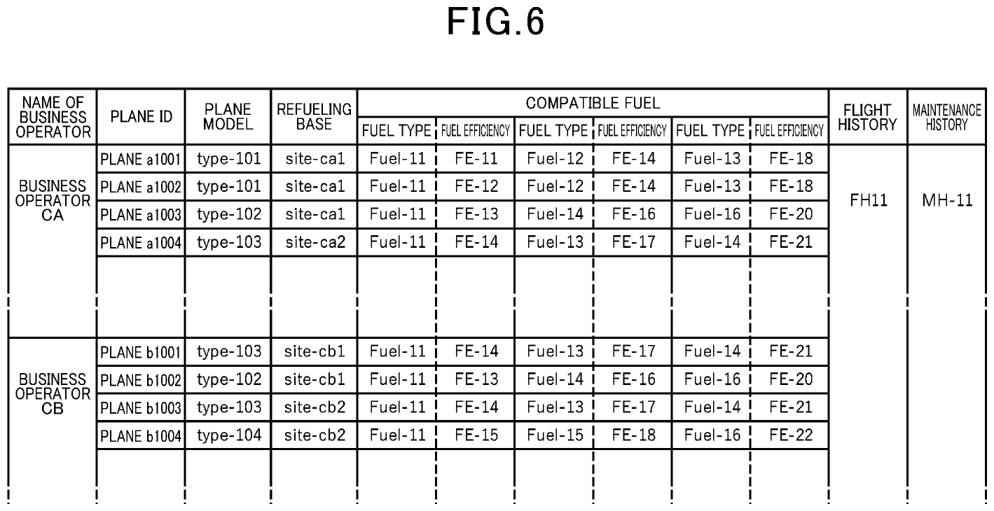

FIG. 6 is a view showing one example of the business operator information 506 that the information collection unit 510 generates and stores in the storage device 502. The business operator information shown in FIG. 6 is classified by the business operator and composed of the plane ID, the plane model, the refueling base, the compatible fuel, the flight history, and the maintenance history of each aircraft that is an operating asset. For the compatible fuel, the type of fuel compatible with each aircraft and the fuel efficiency of each type of fuel (e.g., a flight distance per liter of fuel) are shown.

The plane ID, the plane model, and the refueling base included in the business operator information are obtained, for example, from the asset information 206 that the information collection unit 510 has received from the business operator server 102. The compatible fuel is obtained, for example, by the information collection unit 510 extracting information on the compatible fuel corresponding to the plane model from the equipment information 404 received from the equipment information server 108.

The flight history and the maintenance history are acquired from the operation information 208 and the service information 210, respectively, that the information collection unit 510 has received from the business operator server 102. In the flight history column and the maintenance history column of the business operator information shown in FIG. 6, for example, start addresses of storage areas of the storage device 502 in which the corresponding flight history and maintenance history are stored are shown.

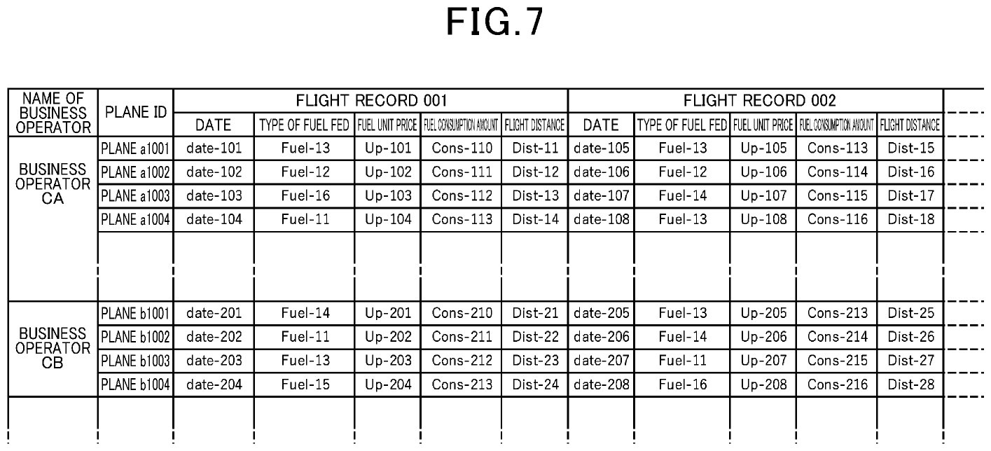

FIG. 7 is a view showing one example of the flight history included in the business operator information shown in FIG. 6. The flight history shown in FIG. 7 is classified by the business operator and composed of the plane ID and the flight record of each aircraft that is an operating asset. Each of “flight record 001” and “flight record 002” in the table shown in FIG. 7 corresponds to a flight record of one flight. These flight records include the date of flight, the fuel fed, the fuel unit price, the fuel consumption, and the flight distance. “Type of fuel fed” shows the type of fuel that was fed, and “fuel unit price” shows the unit price of the fuel that was fed. “Fuel consumption amount” is an amount of fuel that was consumed by flying the flight distance shown in the column “flight distance.”

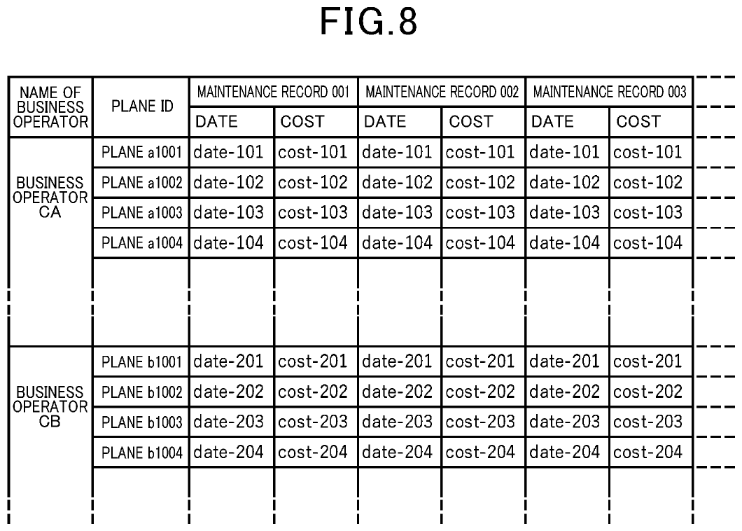

FIG. 8 is a view showing one example of the maintenance history included in the business operator information shown in FIG. 6. The maintenance history shown in FIG. 8 is classified by the business operator and composed of a maintenance record for each aircraft that is an operating asset. Each of “maintenance record 001,” “maintenance record 002,” and “maintenance record 003” in the table shown in FIG. 8 corresponds to a maintenance record of one maintenance work. Each maintenance record is composed of the “date” on which maintenance is performed and the “cost” that is the total cost required for the maintenance work.

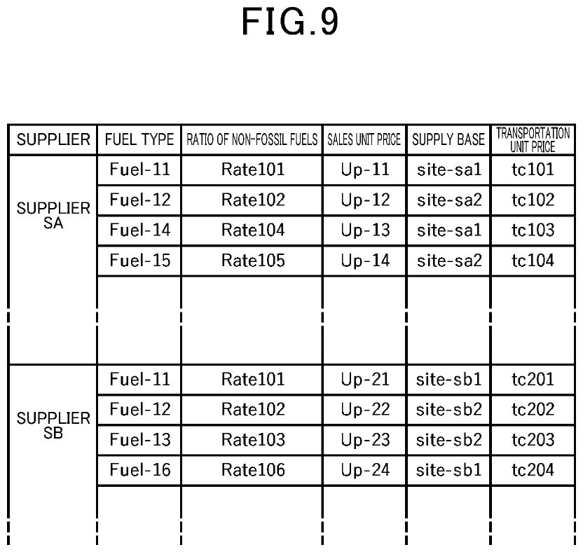

FIG. 9 is a view showing one example of the supplier information 508 that the information collection unit 510 generates and stores in the storage device 502. The supplier information shown in FIG. 8 is classified by the suppliers and composed of “fuel type,” “ratio of non-fossil fuels,” “sales unit price,” “supply base,” and “transportation unit price.” “Fuel type” is the type of fuel that the supplier sells. “Ratio of non-fossil fuels” is the content of non-fossil fuels in that fuel. “Sales unit price” is the unit price of that fuel (e.g., a price per liter). “Supply base” is the location of the supply base of that fuel, and “transportation unit price” shows, for example, the transportation fee per kilometer of that fuel.

It is assumed that all the types of fuels Fuel-11, -12, -13, -14, -15, and -16 listed in the information shown in FIG. 6 to FIG. 9 are fuels containing non-fossil fuels, i.e., either non-fossil fuels or mixed fuels of non-fossil fuels and fossil fuels.

Referring to FIG. 5, based on the business operator information 506 and the supplier information 508 stored in the supply-demand database 504 stored in the storage device 502, the matching unit 512 extracts and outputs, for each business operator, a suitable supplier for the business operator to receive a supply of fuel from by using given matching conditions. The matching unit 512 extracts a suitable supplier to supply fuel, for example, upon receiving a matching request from one of the business operator servers 102.

In this embodiment, the matching conditions include a first condition about the compatibility between the operating asset of the business operator and the type of fuel supplied by the supplier, and a second condition about the geographical relationship between the refueling base of the operating asset and the supply base of the supplier, and both the conditions are provided for each business operator.

Specifically, the first condition can be, for example, that “a supplier who supplies the type of fuel compatible with the operating asset of the business operator is selected,” or that “a supplier who supplies a fuel that maximizes the throughput per unit fuel price for the operating asset of the business operator is selected.”

The second condition can be, for example, that “a supplier who has a supply base closest to the refueling base of the operating asset of the business operator is selected,” or that “a supplier who minimizes the total cost required to refuel the operating asset of the business operator is selected.”

For each business operator, the matching unit 512 determines whether the individual suppliers meet the first condition based on the type of the operating asset included in the business operator information 506 and the type of fuel included in the supplier information 508, and determines whether the individual suppliers meet the second condition based on the refueling base included in the business operator information 506 and the supply base included in the supplier information 508. Then, the matching unit 512 determines a supplier who meets both the first condition and the second condition for the business operator to be a suitable supplier for the business operator to receive a supply of fuel from.

For example, based on information on the fuel type of each compatible fuel and/or the refueling base for each plane ID that are included in the business operator information 506 as shown in FIG. 6, as well as on information on the fuel type, the sales unit price, and/or the transportation unit price indicated by the supplier information 508 as shown in FIG. 9, the matching unit 512 extracts, for each business operator, a supplier who meets both the first condition and the second condition, and generates matching information. The matching information generated by the matching unit 512 is sent to the business operator server 102 of the corresponding business operator by the information provision unit 516 to be described later.

Thus, the fuel supply-demand matching system 100 can effectively match a business operator who does business using an operating asset that consumes fuel, such as an aircraft, with a fuel supplier who supplies fuel as business. Thus, for example, using the fuel supply-demand matching system 100 for supply-demand matching relating to non-fossil fuels and/or mixed fuels as in this embodiment can promote the use of non-fossil fuels toward the realization of a decarbonized society.

Referring to FIG. 5, the evaluation unit 514 evaluates business operators who use non-fossil fuels or mixed fuels, and outputs business support information for each business operator. Specifically, for each business operator, the evaluation unit 514 quantifies the degree of reduction of environmental load as compared with when only fossil fuels are used based on the amount of non-fossil fuels consumed, and outputs the quantified degree of reduction of environmental load as one piece of business support information.

For example, based on the operation history included in the business operator information 506, for example, information on the type of fuel fed and the fuel consumption amount included in each flight record indicated by the flight history as shown in FIG. 7, and information on the ratio of non-fossil fuels indicated by the supplier information 508 as shown in FIG. 9, the evaluation unit 514 calculates, once every six months, the total amount of non-fossil fuels (including non-fossil fuels contained in mixed fuels) that the business operator has consumed on all aircraft during a six-month period, and the total distance flown during the six-month period.

Further, based on the total flight distance during the six-month period of each aircraft, and fuel efficiency when using fossil fuels that is estimated from the model of the aircraft, the evaluation unit 514 calculates a virtual consumption amount of fossil fuels that would have been consumed during the six-month period if all aircraft had used only fossil fuels.

Then, based on the total consumption amount of non-fossil fuels and the virtual consumption amount of fossil fuels thus calculated, the evaluation unit 514 outputs, as the amount of reduction of environmental load, a difference in the amount of CO₂ emissions that is obtained by subtracting an amount of CO₂ emissions that must have been produced when non-fossil fuels corresponding to the total consumption amount were burned from an amount of CO₂ emissions that is based on the assumption of burning fossil fuels corresponding to the virtual consumption amount.

Or the evaluation unit 514 can quantify and output, for each flight, the degree of reduction of environmental load resulting from using non-fossil fuels in real time during the flight of the aircraft, or after the flight. Specifically, based on information on the amount of fuel consumed in a flight from takeoff to a current time and information on the ratio of non-fossil fuels in the fuel fed in the flight, the evaluation unit 514 calculates an amount of non-fossil fuels (including non-fossil fuels contained in mixed fuels) consumed from the takeoff to the current time.

Further, based on the distance flown in the flight from the takeoff to the current time and the fuel efficiency when using fossil fuels that is estimated from the model of the aircraft, the evaluation unit 514 calculates a virtual amount of fossil fuels consumed from the takeoff to the current time based on the assumption of using only fossil fuels in that flight. Moreover, based on the total consumption amount of non-fossil fuels and the virtual consumption amount of fossil fuels thus calculated, the evaluation unit 514 calculates the difference in the amount of CO₂ emissions by subtracting an amount of CO₂ emissions that must have been produced when non-fossil fuels corresponding to the total consumption amount were burned from an amount of CO₂ emissions that is based on the assumption of burning fossil fuels corresponding to the virtual consumption amount. Then, the evaluation unit 514 outputs the difference in the amount of CO₂ emissions thus calculated as the amount of reduction of environmental load achieved in the flight from the takeoff to the current time.

Thus, the business operator can quantitatively grasp how much it contributes to the reduction of environmental load by using non-fossil fuels, which helps maintain or enhance the motivation to use non-fossil fuels. As a result, the fuel supply-demand matching system 100 can further promote the use of non-fossil fuels.

For those business operators who have used non-fossil fuels or mixed fuels of non-fossil fuels and fossil fuels (in this embodiment, fossil fuels), the evaluation unit 514 quantifies the degree of reduction of the maintenance cost of the operating asset as compared with when only fossil fuels are used, and outputs the quantified degree of reduction of the maintenance cost as one piece of business support information.

For example, the evaluation unit 514 calculates, once every six months, a total flight distance of all aircraft during a six-month period from the flight record indicated by the flight history of the business operator information 506 as shown in FIG. 7. Further, the evaluation unit 514 calculates, as a virtual cost, a total maintenance cost of the six-month period based on the assumption of using only fossil fuels by multiplying, by a standard maintenance cost, the number of times of maintenance of all aircraft that would have been required if the calculated total flight distance had been flown using only fossil fuels. Moreover, the evaluation unit 514 calculates, as an actual cost, a sum of the maintenance costs of the six-month period indicated by the maintenance history of the business operator information 506 as shown in FIG. 8. Then, the evaluation unit 514 outputs, as the amount of reduction of the maintenance cost, a cost obtained by subtracting the actual cost from the virtual cost calculated as described above. Here, information needed to calculate the number of times of maintenance based on the assumption of flying using only fossil fuels and information on the standard maintenance cost can be acquired, for example, from the equipment information server 108.

Thus, the business operator can quantitatively grasp the merit of introducing non-fossil fuels or mixed fuels from the viewpoint of maintenance costs that can affect upkeep costs of the operating assets, which further helps maintain or enhance the motivation to use non-fossil fuels. As a result, the fuel supply-demand matching system 100 can further promote the use of non-fossil fuels.

As a form of output of the business support information output by the evaluation unit 514, for example, the evaluation unit 514 can display the business support information through a predetermined website operated by the matching server 106, or through a mobile terminal (e.g., the mobile terminal 600 shown in FIG. 1), such as a smartphone, that executes application software provided by the matching server 106. As in the related art, such display of business support information can be viewed by users who have a predetermined access right.

For example, the evaluation unit 514 can output the degree of reduction of the amount of CO₂ emissions in the form of a list of ranking by the business operator such that it can be displayed on the website or the mobile terminal.

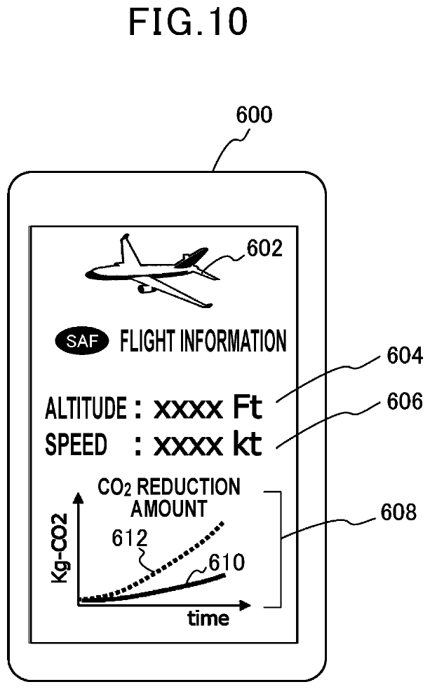

For example, the evaluation unit 514 can output the above-described degree of reduction of environmental load in each flight such that it can be displayed on the mobile terminal as shown in FIG. 10. In the example shown in FIG. 10, an altitude display 604, a speed display 606, and a CO₂ reduction amount display 608 are displayed on a display screen 602 of the mobile terminal 600. The CO₂ reduction amount display 608 displays an estimated CO₂ emission amount 610 based on a non-fossil fuel (or a mixed fuel) that the aircraft is currently using, and a reference emission amount 612 that is the amount of CO₂ emissions produced when a fossil fuel is used, and a CO₂ reduction amount is indicated as the difference between the estimated emission amount 610 and the reference emission amount 612.

Referring to FIG. 5, the information provision unit 516 provides the matching information output by the matching unit 512 and the business support information output by the evaluation unit 514 to the corresponding business operator. Specifically, the information provision unit 516 sends the matching information and the business support information to the business operator server 102 of the corresponding business operator.

Further, when the information provision unit 516 has provided the business operator with an output about the degree of reduction of environmental load as the business support information, the information provision unit 516 determines the compensation for the provision of the output based on the number of times the output about the degree of reduction of environmental load has been provided, or to the degree of reduction of environmental load that the evaluation unit 514 has output about the business operator. The degree of reduction of environmental load is, for example, the amount of reduction of CO₂ emissions as described above.

When the information provision unit 516 has provided the business operator with an output about the degree of reduction of the maintenance cost as the business support information, the information provision unit 516 determines the compensation for the provision of the output based on the number of times the output about the degree of reduction of the maintenance cost has been provided, or to the degree of reduction of the maintenance cost that the evaluation unit 514 has output about the business operator.

Thus, the operator of the fuel supply-demand matching system 100 can charge an appropriate incentive according to the merits for the business operator.

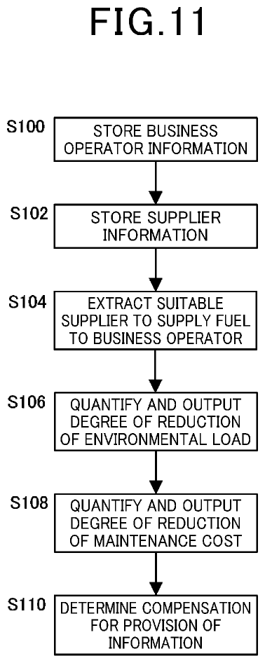

Next, the procedure of a fuel supply-demand matching method executed by the fuel supply-demand matching system 100 will be described. FIG. 11 is a flowchart showing the procedure of the fuel supply-demand matching method. The fuel supply-demand matching method is executed by the computer included in the fuel supply-demand matching system 100, specifically the processing device 500 that is a computer included in the matching server 106 constituting a part of the fuel supply-demand matching system 100, through cooperation with the processing devices 200, 300, and 400 that are computers included in the business operator server 102, the supplier server 104, and/or the equipment information server 108.

The fuel supply-demand matching method has a step (S100) in which the information collection unit 510 of the matching server 106 collects information about business operators who do business using operating assets that operate by consuming fuel, and stores this information in the storage device 502 as the business operator information 506, and a step (S102) in which the information collection unit 510 collects information about suppliers who supply fuel as business, and stores this information in the storage device 502 as the supplier information 508. As described above, the business operator information 506 includes information about operating assets that each business operator uses in business and information about the locations of refueling bases of the operating assets. The supplier information includes information about the types of fuels supplied by each supplier and information about the locations of supply bases of the fuels.

The fuel supply-demand matching method further includes a step (S104) in which, based on the business operator information and the supplier information, the matching unit 512 of the matching server 106 extracts and outputs a suitable supplier for a business operator to receive a supply of the fuel from by using given matching conditions. As described above, the given matching conditions include the first condition about the compatibility between the operating asset of the business operator and the type of fuel supplied by the supplier, and the second condition about the geographical relationship between the refueling base of the operating asset and the supply base of the supplier.

The fuel supply-demand matching method further includes a step (S106) in which, based on an amount of non-fossil fuels consumed, the evaluation unit 514 of the matching server 106 quantifies the degree of reduction of environmental load as compared with when only fossil fuels are used, and outputs the result as one piece of the business support information.

The fuel supply-demand matching method further includes a step (S108) in which, for those business operators who have used non-fossil fuels or mixed fuels, the evaluation unit 514 quantifies the degree of reduction of the maintenance cost of the operating asset as compared with when only fossil fuels are used, and outputs the result as one piece of the business support information.

In addition, the fuel supply-demand matching method include a step (S110) in which the information provision unit 516 of the matching server 106 determines a compensation for the provision of the output in step S104, S106 and/or S108 to the business operator. As described above, this compensation can be determined based on the number of times of output, or the degree of reduction of environmental load or the degree of reduction of the maintenance cost output by the evaluation unit 514.

The present invention is not limited to the configurations of the above-described embodiment and modified examples thereof, but can be implemented in various forms within a range that does not depart from the gist of the invention.

For example, the business operators in the fuel supply-demand matching system 100 described above are airlines that transport passengers and freight using aircraft as operating assets, but the business operators are not limited to airlines. The business operators can be any business operators who do business using operating assets that operate by consuming fuel. For example, the business operators may be taxi companies, car rental companies, bus companies, or transport companies that transport passengers and freight using vehicles as operating assets. Or the business operators may be building companies that have, as operating assets, building work-related vehicles that consume fuel, such as construction vehicles.

The business operator information 506 includes information about operating assets used in business in the above-described embodiment, but may include information about the type of business instead of information about operating assets. The type of business can be, for example, truck transportation, or passenger transportation by taxis. In this case, the matching unit 512 can determine what operating asset is used in the business from the type of business, and identify the type of non-fossil fuel that can be generally deemed to be suitable for that operating asset, and then extract a supplier suitable for that business operator.

The above-described embodiment supports the following configurations.

Configuration 1: A fuel supply-demand matching system including: a storage device that stores business operator information about business operators who do business using an operating asset that operates by consuming fuel, and supplier information about suppliers who supply the fuel as business; and a matching unit that, based on the business operator information and the supplier information, extracts and outputs a suitable supplier for a business operator to receive a supply of the fuel from by using given matching conditions, wherein: the business operator information includes information about the type of the business or the operating asset used in the business of each of the business operators, and information about the location of a refueling base of the operating asset; the supplier information includes information about the type of the fuel supplied by each of the suppliers, and information about the location of a supply base of the fuel; and the matching conditions include a first condition about the compatibility between the operating asset and the type of fuel, and a second condition about the geographical relationship between the refueling base and the supply base, both the conditions being provided for each of the business operators.

The fuel supply-demand matching system of Configuration 1 can effectively match a business operator who does business using an operating asset that consumes fuel, such as an aircraft, with a fuel supplier who supplies fuel as business. Thus, for example, performing supply-demand matching relating to non-fossil fuels using the fuel supply-demand matching system of Configuration 1 can promote the use of non-fossil fuels that are effective for the realization of a decarbonized society.

Configuration 2: The fuel supply-demand matching system according to Configuration 1, wherein: for each of the business operators, the matching unit determines whether the individual suppliers meet the first condition based on the type of the operating asset or the type of business included in the business operator information and the type of fuel included in the supplier information, and determines whether the individual suppliers meet the second condition based on the refueling base included in the business operator information and the supply base included in the supplier information; and the matching unit determines a supplier who meets both the first condition and the second condition for the business operator to be a suitable supplier for the business operator to receive a supply of the fuel from.

The fuel supply-demand matching system of Configuration 2 can more appropriately match a business operator who does business using an operating asset that consumes fuel, such as an aircraft, with a fuel supplier who supplies fuel as business.

Configuration 3: The fuel supply-demand matching system according to Configuration 1 or 2, wherein the first condition includes a condition about a throughput of the operating asset per fuel consumption amount for each type of fuel.

The fuel supply-demand matching system of Configuration 3 can more effectively match a business operator who does business using an operating asset that consumes fuel, such as an aircraft, with a fuel supplier who supplies fuel as business, from the viewpoint of the cost performance of the operating asset that depends on the type of fuel.

Configuration 4: The fuel supply-demand matching system according to any one of Configurations 1 to 3, wherein: the types of fuels supplied by the suppliers include non-fossil fuels or mixed fuels of non-fossil fuels and fossil fuels; the fuel supply-demand matching system includes an evaluation unit that evaluates business operators who use non-fossil fuels or mixed fuels; and for each of the business operators, the evaluation unit quantifies and outputs, based on an amount of the non-fossil fuels consumed, a degree of reduction of environmental load as compared with when only fossil fuels are used.

The fuel supply-demand matching system of Configuration 4 allows the business operators to quantitatively grasp how much they contribute to the reduction of environmental load by using non-fossil fuels, which helps maintain or enhance the motivation to use non-fossil fuels. As a result, the fuel supply-demand matching system can further promote the use of non-fossil fuels.

Configuration 5: The fuel supply-demand matching system according to Configuration 4, including an information provision unit that provides each of the business operators with an output of the evaluation unit, wherein, when the information provision unit has provided the business operator with an output about the degree of reduction of environmental load, the information provision unit determines a compensation for the provision of the output according to the number of times the output about the degree of reduction of environmental load has been provided, or to the degree of reduction of environmental load that the evaluation unit has output about the business operator.

The fuel supply-demand matching system of Configuration 5 allows the operator of the fuel supply-demand matching system to charge an appropriate incentive according to the merits for the business operators.

Configuration 6: The fuel supply-demand matching system according to any one of Configurations 1 to 5, wherein: the types of fuels supplied by the suppliers include non-fossil fuels or mixed fuels of non-fossil fuels and fossil fuels; the fuel supply-demand matching system includes an evaluation unit that evaluates business operators who use non-fossil fuels or mixed fuels; and for each of the business operators who have used non-fossil fuels or mixed fuels, the evaluation unit quantifies and outputs a degree of reduction of a maintenance cost of the operating asset as compared with when only fossil fuels are used.

The fuel supply-demand matching system of Configuration 6 allows the business operators to quantitatively grasp the merit of introducing non-fossil fuels from the viewpoint of maintenance costs that can affect upkeep costs of the operating assets, which further helps maintain or enhance the motivation to use non-fossil fuels. As a result, the fuel supply-demand matching system can further promote the use of non-fossil fuels.

Configuration 7: The fuel supply-demand matching system according to Configuration 6, including an information provision unit that provides each of the business operators with an output of the evaluation unit, wherein, when the information provision unit has provided the business operator with an output about the degree of reduction of the maintenance cost, the information provision unit determines a compensation for the provision of the output according to the number of times the output about the degree of reduction of the maintenance cost has been provided, or to the degree of reduction of the maintenance cost that the evaluation unit has output about the business operator.

The fuel supply-demand matching system of Configuration 7 allows the operator of the fuel supply-demand matching system to charge an appropriate incentive according to the merits for the business operators.

Configuration 8: The fuel supply-demand matching system according to any one of Configurations 1 to 7, including: a matching server including the matching unit; one or more supplier servers that each provide the matching server with information about the type of fuel supplied by a corresponding supplier; one or more business operator servers that each provide the matching server with information about the model of the operating asset of a corresponding business operator; and one or more equipment information servers that each provide the matching server with information about the type of fuel that is compatible with the model of the operating asset.

The fuel supply-demand matching system of Configuration 8 can effectively match a business operator with a fuel supplier by not only collaborating with the servers of business operators and fuel suppliers but also collaborating with a server that provides information on the specifications of the operating assets of the business operators, for example, a server of a manufacturer.

Configuration 9: A fuel supply-demand matching method executed by a computer, including the steps of: storing, in a storage device, business operator information about business operators who do business using an operating asset that operates by consuming fuel; storing, in the storage device, supplier information about suppliers who supply the fuel as business; and based on the business operator information and the supplier information, extracting and outputting a suitable supplier for a business operator to receive a supply of the fuel from by using given matching conditions, wherein: the business operator information includes information about the type of the business or the operating asset used in the business of each of the business operators, and information about the location of a refueling base of the operating asset; the supplier information includes information about the type of the fuel supplied by each of the suppliers, and information about the location of a supply base of the fuel; and the matching conditions include a first condition about the compatibility between the operating asset and the type of fuel, and a second condition about the geographical relationship between the refueling base and the supply base, both the conditions being provided for each of the business operators.

The fuel supply-demand matching method of Configuration 9 can effectively match a business operator who does business using an operating asset that consumes fuel, such as an aircraft, with a fuel supplier who supplies fuel as business. Thus, for example, performing supply-demand matching relating to non-fossil fuels using the fuel supply-demand matching method of Configuration 9 can promote the use of non-fossil fuels that are effective for the realization of a decarbonized society.
100 Fuel supply-demand matching system
102 Business operator server
104 Supplier server
106 Matching server
108 Equipment information server
110 Communication network
200, 300, 400, 500 Processing device
202, 302, 402, 502 Storage device
206 Asset information
208 Operation information
210 Service information
212 Asset management unit
214 Operation management unit
216 Business information provision unit
218 Business support unit
304 Merchandise information
306 Stock information
310 Merchandise management unit
312 Stock management unit
314 Fuel information provision unit
404 Equipment information
410 Equipment information management unit
412 Equipment information provision unit
504 Supply-demand database
506 Business operator information
508 Supplier information
510 Information collection unit
512 Matching unit
514 Evaluation unit
516 Information provision unit
600 Mobile terminal
602 Display screen
604 Altitude display
606 Speed display
608 CO₂ reduction amount display
610 Estimated emission amount
612 Reference emission amount

What is claimed is:

1. A fuel supply-demand matching system comprising:
a storage device that stores business operator information about business operators who do business using an operating asset that operates by consuming fuel, and supplier information about suppliers who supply the fuel as business; and
a matching unit that, based on the business operator information and the supplier information, extracts and outputs a suitable supplier for a business operator to receive a supply of the fuel from by using given matching conditions, wherein:
the business operator information includes information about a type of the business or the operating asset used in the business of each of the business operators, and information about a location of a refueling base of the operating asset;
the supplier information includes information about a type of the fuel supplied by each of the suppliers, and information about a location of a supply base of the fuel; and
the matching conditions include a first condition about compatibility between the operating asset and the type of fuel, and a second condition about a geographical relationship between the refueling base and the supply base, both the conditions being provided for each of the business operators.

2. The fuel supply-demand matching system according to claim 1, wherein:
for each of the business operators, the matching unit determines whether the individual suppliers meet the first condition based on a type of the operating asset or the type of business included in the business operator information and the type of fuel included in the supplier information, and determines whether the individual suppliers meet the second condition based on the refueling base included in the business operator information and the supply base included in the supplier information; and
the matching unit determines a supplier who meets both the first condition and the second condition for the business operator to be a suitable supplier for the business operator to receive a supply of the fuel from.

3. The fuel supply-demand matching system according to claim 1, wherein the first condition includes a condition about a throughput of the operating asset per fuel consumption amount for each type of fuel.

4. The fuel supply-demand matching system according to claim 1, wherein:
the types of fuels supplied by the suppliers include non-fossil fuels or mixed fuels of non-fossil fuels and fossil fuels;
the fuel supply-demand matching system comprises an evaluation unit that evaluates business operators who use non-fossil fuels or mixed fuels; and
for each of the business operators, the evaluation unit quantifies and outputs, based on an amount of the non-fossil fuels consumed, a degree of reduction of environmental load as compared with when only fossil fuels are used.

5. The fuel supply-demand matching system according to claim 4, comprising an information provision unit that provides each of the business operators with an output of the evaluation unit, wherein, when the information provision unit has provided the business operator with an output about the degree of reduction of environmental load, the information provision unit determines a compensation for the provision of the output according to the number of times the output about the degree of reduction of environmental load has been provided, or to the degree of reduction of environmental load that the evaluation unit has output about the business operator.

6. The fuel supply-demand matching system according to claim 1, wherein:
the types of fuels supplied by the suppliers include non-fossil fuels or mixed fuels of non-fossil fuels and fossil fuels;
the fuel supply-demand matching system comprises an evaluation unit that evaluates business operators who use non-fossil fuels or mixed fuels; and
for each of the business operators who have used non-fossil fuels or mixed fuels, the evaluation unit quantifies and outputs a degree of reduction of a maintenance cost of the operating asset as compared with when only fossil fuels are used.

7. The fuel supply-demand matching system according to claim 6, comprising an information provision unit that provides each of the business operators with an output of the evaluation unit, wherein, when the information provision unit has provided the business operator with an output about the degree of reduction of the maintenance cost, the information provision unit determines a compensation for the provision of the output according to the number of times the output about the degree of reduction of the maintenance cost has been provided, or to the degree of reduction of the maintenance cost that the evaluation unit has output about the business operator.

8. The fuel supply-demand matching system according to claim 1, comprising:
a matching server including the matching unit;
one or more supplier servers that each provide the matching server with information about a type of fuel supplied by a corresponding supplier;
one or more business operator servers that each provide the matching server with information about a model of the operating asset of a corresponding business operator; and
one or more equipment information servers that each provide the matching server with information about a type of fuel that is compatible with the model of the operating asset.

9. A fuel supply-demand matching method executed by a computer, comprising the steps of:
storing, in a storage device, business operator information about business operators who do business using an operating asset that operates by consuming fuel;
storing, in the storage device, supplier information about suppliers who supply the fuel as business; and
based on the business operator information and the supplier information, extracting and outputting a suitable supplier for a business operator to receive a supply of the fuel from by using given matching conditions, wherein:
the business operator information includes information about a type of the business or the operating asset used in the business of each of the business operators, and information about a location of a refueling base of the operating asset;
the supplier information includes information about a type of the fuel supplied by each of the suppliers, and information about a location of a supply base of the fuel; and
the matching conditions include a first condition about compatibility between the operating asset and the type of fuel, and a second condition about a geographical relationship between the refueling base and the supply base, both the conditions being provided for each of the business operators.
